(19) United States
(12) Patent Application Publication
(10) Pub. No.: US 2019/0258982 A1
(43) Pub. Date: Aug. 22, 2019

(54) CONTROL DEVICE AND MACHINE LEARNING DEVICE

(71) Applicant: Fanuc Corporation, Minamitsuru-gun (JP)

(72) Inventor: Yoshiyuki Suzuki, Minamitsuru-gun (JP)

(73) Assignee: Fanuc Corporation, Minamitsuru-gun (JP)

(21) Appl. No.: 16/274,647

(22) Filed: Feb. 13, 2019

(30) Foreign Application Priority Data
Feb. 19, 2018 (JP) 2018-027009

(51) Int. Cl. G06Q 10/06; G06N 20/00; B30B 15/14; B30B 9/00; G06N 3/04

(52) U.S. Cl. CPC G06Q 10/06395; G06N 20/00; G06N 3/04; B30B 9/00; B30B 15/14

(57) ABSTRACT

A machine learning device included in a control device includes: a state observation section for observing control command data representing a control command for a servo press and control feedback data representing feedback for control as a state variable representing a current environmental state; a determination data acquisition section for acquiring workpiece quality determination data for determining the quality of a workpiece machined based on the control command for the servo press and cycle time determination data for determining the time taken to machine the workpiece as determination data representing a result of determination regarding the machining of the workpiece; and a learning section for learning the control command for the servo press in relation to the feedback for controlling the servo press.

### BACKGROUND OF THE INVENTION

### 1. Field of the Invention

The present invention relates to a control device and a machine learning device.

### 2. Description of the Related Art

In presses (servo presses) that use servo motors to control axes, a control device gives the same command values (such as a position command value, a speed command value, a pressure command value, and a torque command value) to the servo motors in every cycle to accurately control the position and speed of a slide and drive the slide up and down, thus machining a workpiece (for example, Japanese Patent Application Laid-Open No. 2004-17098).

Such a servo press may not necessarily have the same result in every cycle even if the same command values are given to the servo motors in every cycle, due to external factors, such as mechanical states (such as accumulated damage to a die) of the servo press and, in the case of a punch press, vibrations (breakthrough) caused by shock given to the machine at the time of punching. This may result in, for example, a decrease in machining accuracy or a failure in machining. In the worst case, the machine may be seriously damaged by, for example, a direct collision between upper and lower dies.

Operators have heretofore dealt with such problems by adjusting command values and dies based on their experiences and the like. However, such adjustment of command values and dies are difficult for less-experienced operators.

### SUMMARY OF THE INVENTION

An object of the present invention is to provide a control device and a machine learning device that can improve machining quality without increasing cycle time more than necessary in the machining of a workpiece by a servo press.

One aspect of the present invention is a control device for controlling a servo press that machines a workpiece with a die. The control device includes a machine learning device for learning a control command for the servo press. The machine learning device includes: a state observation section for observing control command data representing the control command for the servo press and control feedback data representing feedback for controlling the servo press as a state variable representing a current environmental state; a determination data acquisition section for acquiring workpiece quality determination data for determining quality of a workpiece machined based on the control command for the servo press as determination data representing a result of determination regarding machining of the workpiece; and a learning section for learning the control command for the servo press in relation to the feedback for controlling the servo press using the state variable and the determination data.

Another aspect of the present invention is a control device for controlling a servo press that machines a workpiece with a die. The control device includes a machine learning device that has learned a control command for the servo press. The machine learning device includes: a state observation section for observing control command data representing the control command for the servo press and control feedback data representing feedback for controlling the servo press as a state variable representing a current environmental state; a learning section that has learned the control command for the servo press in relation to the feedback for controlling the servo press; and a decision-making section for deciding the control command for the servo press based on the state variable observed by the state observation section and a result of learning by the learning section.

Another aspect of the present invention is a machine learning device for learning a control command for a servo press that machines a workpiece with a die. The machine learning device includes: a state observation section for observing control command data representing the control command for the servo press and control feedback data representing feedback for controlling the servo press as a state variable representing a current environmental state; a determination data acquisition section for acquiring workpiece quality determination data for determining quality of a workpiece machined based on the control command for the servo press as determination data representing a result of determination regarding machining of the workpiece; and a learning section for learning the control command for the servo press in relation to the feedback for controlling the servo press using the state variable and the determination data.

Another aspect of the present invention is a machine learning device that has learned a control command for a servo press for machining a workpiece with a die. The machine learning device includes: a state observation section for observing control command data representing the control command for the servo press and control feedback data representing feedback for controlling the servo press as a state variable representing a current environmental state; a learning section that has learned the control command for the servo press in relation to the feedback for controlling the servo press; and a decision-making section for deciding the control command for the servo press based on the state variable observed by the state observation section and a result of learning by the learning section.

In the present invention, machine learning is introduced to decide a control command for a servo press. This refines a command value given from a control device, reduces failure rate, improves machining accuracy, and reduces damage to a die when a failure occurs. Further, a good balance between such machining quality improvements and cycle time is achieved.

### BRIEF DESCRIPTION OF THE DRAWINGS

These and other objects and features of the present invention will become apparent from the following description of exemplary embodiments with reference to the accompanying drawings in which:

FIG. 1 is a hardware configuration diagram schematically illustrating a control device according to a first embodiment;

FIG. 2 is a functional block diagram schematically illustrating the control device according to the first embodiment;

FIG. 3 is a view illustrating examples of control command data S1 and control feedback data S2;

FIG. 4 is a functional block diagram schematically illustrating one aspect of the control device;

FIG. 5 is a flowchart schematically illustrating one aspect of a machine learning method;

FIG. 6A is a diagram for explaining a neuron;

FIG. 6B is a diagram for explaining a neural network;

FIG. 7 is a functional block diagram schematically illustrating a control device according to a second embodiment; and

FIG. 8 is a functional block diagram schematically illustrating one aspect of a system including the control device.

### DETAILED DESCRIPTION OF THE PREFERRED EMBODIMENTS

Hereinafter, embodiments of the present invention will be described with reference to the drawings.

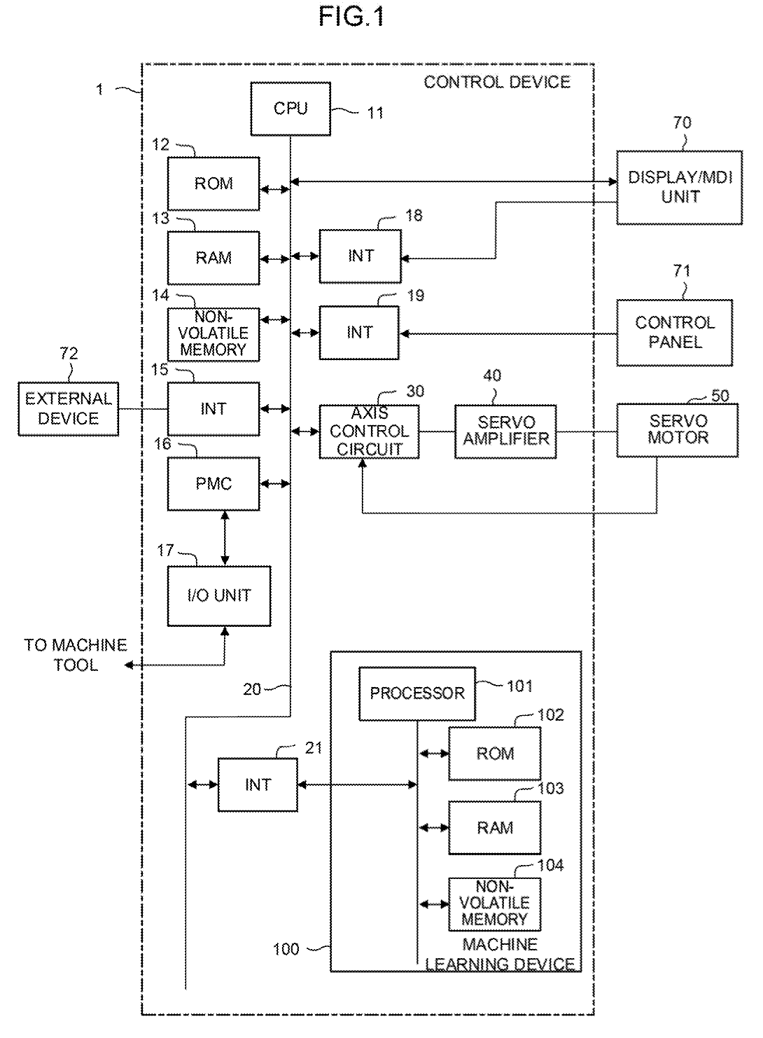

FIG. 1 is a hardware configuration diagram schematically illustrating principal portions of a control device according to a first embodiment. A control device 1 can be implemented as a control device for controlling, for example, a servo press. Alternatively, the control device 1 can be implemented as a personal computer attached to a control device for controlling a servo press or a computer such as a cell computer, a host computer, an edge server, or a cloud server connected to the control device through a wired or wireless network, for example. The present embodiment is an example in which the control device 1 is implemented as a control device for controlling a servo press.

A CPU 11 included in the control device 1 according to the present embodiment is a processor for entirely controlling the control device 1. The CPU 11 reads out a system program stored in a ROM 12 via a bus 20 and controls the whole of the control device 1 in accordance with the system program. A RAM 13 temporarily stores temporary calculation data and display data and various kinds of data which are inputted by an operator via an input section, which is not shown, for example.

A non-volatile memory 14 is backed up by a battery, which is not shown, for example, and thus, the non-volatile memory 14 is configured as a memory whose storage state is maintained even when the control device 1 is turned off. The non-volatile memory 14 stores programs read from an external device 72 through an interface 15, programs inputted through a display/MDI unit 70, and various kinds of data (for example, position command value, speed command value, pressure command value, torque command value, position feedback, speed feedback, pressure feedback, torque feedback, motor current value, motor temperature, machine temperature, ambient temperature, the number of times of die usage, workpiece shape, workpiece material, die shape, die material, machining cycle time, and the like) acquired from various sections of the control device 1 and the servo press. Such programs and various kinds of data stored in the non-volatile memory 14 may be loaded into the RAM 13 at the time of execution or use. The ROM 12 has various kinds of preloaded system programs (including a system program for controlling data exchange with a machine learning device 100, which will be described later) such as a publicly-known analysis program.

The interface 15 is an interface for connecting the control device 1 and the external device 72, such as an adapter. Programs, various parameters, and the like are read from the external device 72. Programs, various parameters, and the like edited in the control device 1 can be stored in external storage means through the external device 72. A programmable machine controller (PMC) 16 outputs signals to the servo press and peripherals (for example, a robot that replaces the workpiece with another) of the servo press through an I/O unit 17 in accordance with a sequence program incorporated in the control device 1, thus controlling the servo press and the peripherals. The PMC 16 receives signals from, for example, various control panel switches and various sensors disposed on the main body of the servo press, and passes the signals to the CPU 11 after performing necessary signal processing.

The display/MDI unit 70 is a manual data input device having a display, a keyboard, and the like. An interface 18 receives a command and data from the keyboard of the display/MDI unit 70 and passes the command and the data to the CPU 11. An interface 19 is connected to a control panel 71 having manual pulse generators or the like that are used to manually drive axes.

Each axis of the servo press has an axis control circuit 30 for controlling the axis. The axis control circuit 30 receives a commanded amount of travel for the axis from the CPU 11 and outputs a command for the axis to a servo amplifier 40. The servo amplifier 40 receives the command and drives a servo motor 50 for moving the axis provided in the servo press. The servo motor 50 of the axis incorporates a position and speed detector, and feeds a position and speed feedback signal received from the position and speed detector back to the axis control circuit 30 to perform feedback control of position and speed. It should be noted that the hardware configuration diagram in FIG. 1 only illustrates one axis control circuit 30, one servo amplifier 40, and one servo motor 50, but actually the control device 1 has the same numbers (which may be one or may be more) of axis control circuits 30, servo amplifiers 40, and servo motors 50 as the number of axes of the servo press.

An interface 21 is an interface for connecting the control device 1 with the machine learning device 100. The machine learning device 100 includes a processor 101 that entirely controls the machine learning device 100, a ROM 102 that stores system programs and the like, a RAM 103 that performs temporary storage in each processing related to machine learning, and a non-volatile memory 104 that is used for storing learning models and the like. The machine learning device 100 can observe various kinds of information (for example, position command value, speed command value, pressure command value, torque command value, position feedback, speed feedback, pressure feedback, torque feedback, motor current value, motor temperature, machine temperature, ambient temperature, the number of times of die usage, workpiece shape, workpiece material, die shape, die material, machining cycle time, and the like) that the control device 1 can acquire through the interface 21. The machine learning device 100 outputs a control command to the control device 1, which controls the operation of the servo press in accordance with the control command.

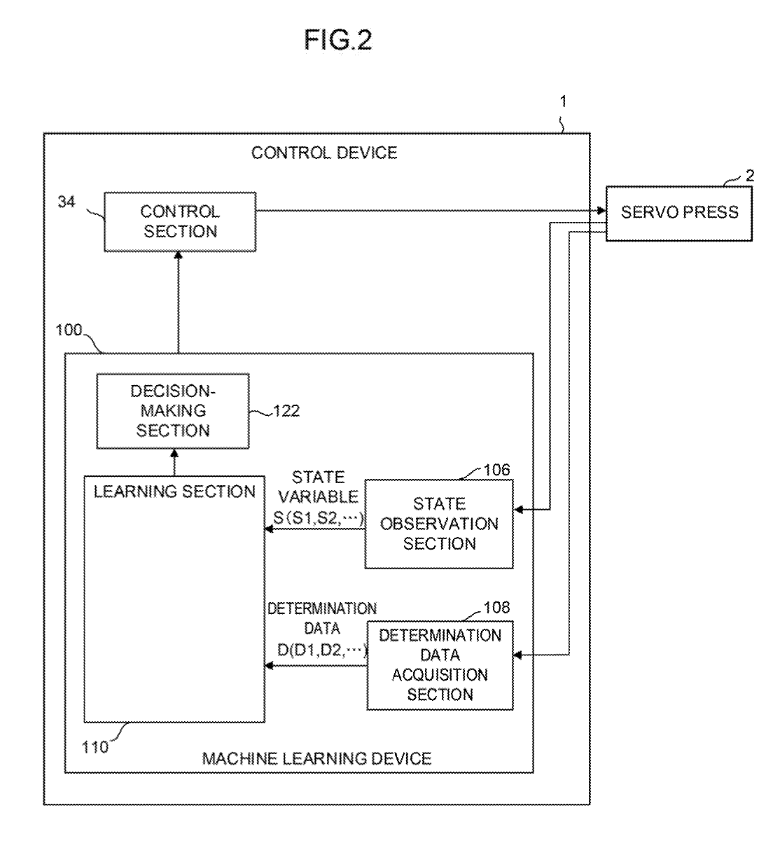

FIG. 2 is a functional block diagram schematically illustrating the control device 1 and the machine learning device 100 according to the first embodiment. Functional blocks illustrated in FIG. 2 are realized when the CPU 11 included in the control device 1 and the processor 101 of the machine learning device 100 which are illustrated in FIG. 1 execute respective system programs and respectively control an operation of each section of the control device 1 and the machine learning device 100.

The control device 1 of the present embodiment includes a control section 34 that controls a servo press 2 based on a control command for the servo press 2 outputted from the machine learning device 100. The control section 34 generally controls the operation of the servo press 2 in accordance with a command from a program or the like but, if the control command for the servo press 2 is outputted from the machine learning device 100, the control section 34 controls the servo press 2 based on the command outputted from the machine learning device 100 instead of a command from the program or the like.

Meanwhile, the machine learning device 100 provided in the control device 1 includes software (such as a learning algorithm) and hardware (such as a processor 101) with which the machine learning device 100 itself learns the control command for the servo press 2 with respect to feedback for controlling the servo press 2 and information on directions of cutting force components of cutting resistance by so-called machine learning. What the machine learning device 100 provided in the control device 1 learns corresponds to a model structure representing the correlation of the feedback for controlling the servo press 2 and information on directions of cutting force components of cutting resistance with the control command for the servo press 2.

As represented by functional blocks in FIG. 2, the machine learning device 100 provided in the control device 1 includes a state observation section 106, a determination data acquisition section 108, and a learning section 110. The state observation section 106 observe state variables S representing a current environmental state which include control command data S1 representing the control command for the servo press 2 and control feedback data S2 representing the feedback for controlling the servo press 2. The determination data acquisition section 108 acquires determination data D that contains workpiece quality determination data D1 for determining the quality of a workpiece machined based on a decided control command for the servo press 2 and cycle time determination data D2 for determining the time taken to machine the workpiece. The learning section 110 learns the control command for the servo press 2 in relation to the feedback for controlling the servo press 2 using the state variables S and the determination data D.

Of the state variables S observed by the state observation section 106, the control command data S1 can be acquired as the control command for the servo press 2. Examples of the control command for the servo press 2 include, for example, a position command value, a speed command value, a pressure command value, a torque command value, and the like for machining by the servo press 2. The control command for the servo press 2 can be acquired from a program for controlling the operation of the servo press 2 or the control command for the servo press 2 outputted in the last learning period.

The control command data S1 may be identical to the control command for the servo press 2 decided by the machine learning device 100 in the last learning period with respect to the feedback for controlling the servo press 2 in the last learning period based on a result of learning by the learning section 110. In the case where such an approach is used, the machine learning device 100 may temporarily store the control command for the servo press 2 in the RAM 103 in each learning period, and the state observation section 106 may acquire the control command for the servo press 2 in the last learning period, which is used as the control command data S1 in the current learning period, from the RAM 103.

Of the state variables S observed by the state observation section 106, the control feedback data S2 can be acquired as a feedback value from the servo motor 50 for driving the servo press 2. Examples of the feedback value from the servo motor 50 include a position feedback value, a speed feedback value, a pressure feedback value, a torque feedback value, and the like.

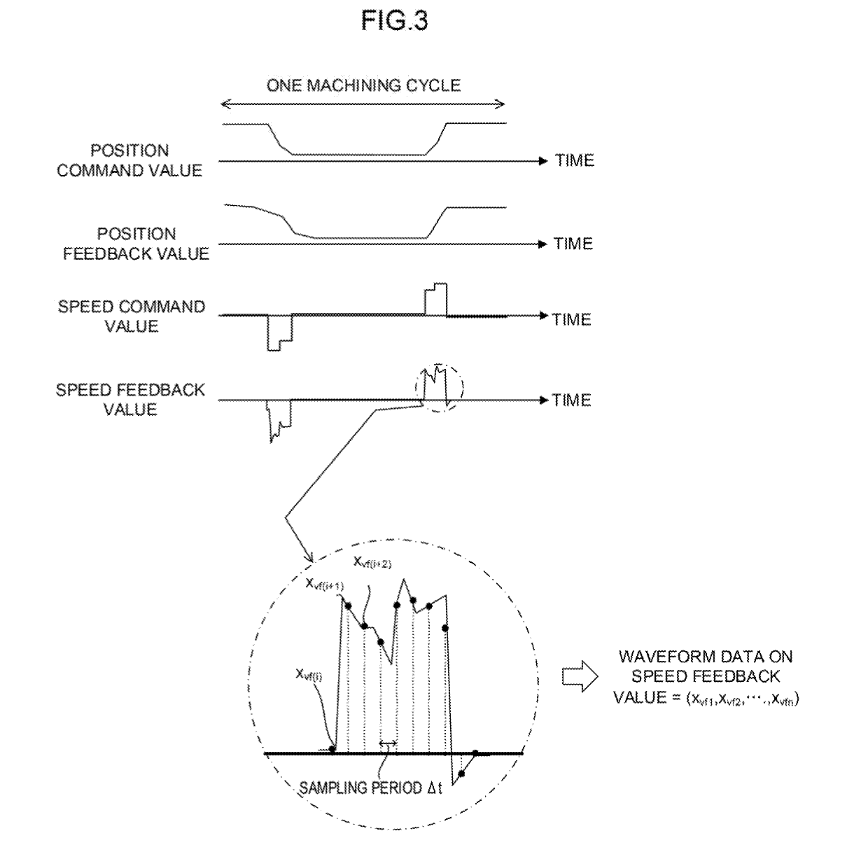

FIG. 3 is a view illustrating examples of the control command data S1 and the control feedback data S2. As illustrated in FIG. 3, the control command data S1 and the control feedback data S2 can be observed as data including temporally-consecutive discrete values obtained by sampling each observed value with a predetermined sampling period Δt. The state observation section 106 may use, as the control command data S1 and the control feedback data S2, data acquired during one machining cycle or data acquired from immediately before the contact of an upper die of the servo press 2 with a workpiece to the moment when pressing work is completely finished. The state observation section 106 outputs the control command data S1 and the control feedback data S2 acquired over the same time interval to the learning section 110 during one learning period of the learning section 110.

Each piece of information acquired during the machining of the workpiece may be stored as log data in the non-volatile memory 14 by the control device 1, and the state observation section 106 may analyze the log data recorded and acquire each state variable.

The determination data acquisition section 108 can use, as the workpiece quality determination data D1, a result of determining the quality of the workpiece machined based on the decided control command for the servo press 2. The workpiece quality determination data D1 which is used by the determination data acquisition section 108 may be a result of determination based on a criterion appropriately set, such as whether the workpiece is a non-defective product (appropriate) or a defective product with scratches, splits, or the like (inappropriate), or whether a dimension error of the workpiece is not more than a predetermined threshold (appropriate) or more than the threshold (inappropriate).

The determination data acquisition section 108 can use, as the cycle time determination data D2, a result of determining the time taken to machine the workpiece based on the decided control command for the servo press 2. The cycle time determination data D2 which is used by the determination data acquisition section 108 may be a result of determination based on a criterion appropriately set, such as whether the time taken to machine the workpiece based on the decided control command for the servo press 2 is shorter than a predetermined threshold (appropriate) or longer than the threshold (inappropriate).

The determination data acquisition section 108 is an essential component in a phase in which the learning section 110 is learning, but is not necessarily an essential component after the learning section 110 completes learning the control command for the servo press 2 in relation to the feedback for controlling the servo press 2. For example, in the case where the machine learning device 100 that has completed learning is shipped to a client, the machine learning device 100 may be shipped after the determination data acquisition section 108 is removed.

From the perspective of learning periods of the learning section 110, the state variables S simultaneously inputted to the learning section 110 are based on data acquired in the last learning period during which the determination data D have been acquired. Thus, during a period in which the machine learning device 100 provided in the control device 1 is learning, the following is repeatedly carried out in the environment: the acquisition of the control feedback data S2, the machining of a workpiece by the servo press 2 based on the control command data S1 decided based on each piece of data acquired, and the acquisition of the determination data D.

The learning section 110 learns the control command for the servo press 2 with respect to the feedback for controlling the servo press 2 in accordance with a freely-selected learning algorithm generically called machine learning. The learning section 110 can repeatedly execute learning based on a data collection containing the state variables S and the determination data D previously described. During the repetition of a learning cycle in which the control command for the servo press 2 is learned with respect to the feedback for controlling the servo press 2, the state variables S are acquired from the feedback for controlling the servo press 2 in the last learning period and the control command for the servo press 2 decided in the last learning period as described previously, and the determination data D are results of determination on the machining of a workpiece machined based on the decided control command for the servo press 2 from various perspectives (such as machining quality and time taken to machine a workpiece).

By repeating the above-described learning cycle, the learning section 110 becomes capable of recognizing features implying the correlation between the feedback for controlling the servo press 2 and the control command for the servo press 2. When the learning algorithm is started, the correlation between the feedback for controlling the servo press 2 and the control command for the servo press 2 is substantially unknown. The learning section 110, however, gradually identifies features and interprets the correlation as learning progresses. When the correlation between the feedback for controlling the servo press 2 and the control command for the servo press 2 is interpreted to some reliable level, learning results repeatedly outputted by the learning section 110 become capable of being used to select an action (that is, make a decision) regarding how the control command for the servo press 2 should be decided with respect to the current state (that is, the feedback for controlling the servo press 2). Specifically, as the learning algorithm progresses, the learning section 110 can gradually bring the correlation between the feedback for controlling the servo press 2 and the control command for the servo press 2, that is, an action regarding how the control command for the servo press 2 should be set with respect to the feedback for controlling the servo press 2, close to the optimal solution.

A decision-making section 122 decides the control command for the servo press 2 based on a learning result of the learning section 110 and outputs the decided control command for the servo press 2 to the control section 34. After learning by the learning section 110 becomes available, when the feedback for controlling the servo press 2 is inputted to the machine learning device 100, the decision-making section 122 outputs the control command for the servo press 2 (such as a position command value, a speed command value, a pressure command value, or a torque command value). The control command for the servo press 2 outputted by the decision-making section 122 is a control command with which the quality of a workpiece can be improved with the machining cycle time maintained to some extent in the current state. The decision-making section 122 decides an appropriate control command for the servo press 2 based on the state variables S and the learning result of the learning section 110.

As described above, in the machine learning device 100 provided in the control device 1, the learning section 110 learns the control command for the servo press 2 with respect to the feedback for controlling the servo press 2 in accordance with a machine learning algorithm using the state variables S observed by the state observation section 106 and the determination data D acquired by the determination data acquisition section 108. The state variables S contain data such as the control command data S1 and the control feedback data S2. The determination data D are unambiguously found by analyzing information acquired from the process of machining a workpiece and a result of measuring the workpiece machined. Accordingly, with the machine learning device 100 provided in the control device 1, the control command for the servo press 2 can be automatically and accurately issued in accordance with the feedback for controlling the servo press 2 by using a learning result of the learning section 110.

Further, if the control command for the servo press 2 can be automatically decided, an appropriate value for the control command for the servo press 2 can be quickly decided only by obtaining the feedback for controlling the servo press 2 (control feedback data S2). Thus, the control command for the servo press 2 can be efficiently decided.

In one modified example of the machine learning device 100 provided in the control device 1, the state observation section 106 may observe, as the state variable S, die state data S3 representing the state of the die in addition to the control command data S1 and the control feedback data S2. Examples of the state of the die include die material, die shape (such as die depth or die maximum curvature), the number of times of die usage, and the like. In the case where the die is made of soft material or where the die is used many times, the die is more likely to be worn or deformed. In the case where the die has a great depth or a sharp edge, the die is more likely to damage a workpiece during machining. Accordingly, observing such state as the state variable S can improve the accuracy of learning by the learning section 110.

In another modified example of the machine learning device 100 provided in the control device 1, the state observation section 106 may observe, as the state variable S, workpiece state data S4 representing the state of a workpiece in addition to the control command data S1 and the control feedback data S2. Since a result of machining may vary depending on workpiece material, workpiece shape before machining, and workpiece temperature, observing such state as the state variable S can improve the accuracy of learning by the learning section 110.

In still another modified example of the machine learning device 100 provided in the control device 1, the state observation section 106 may observe, as the state variable S, motor state data S5 representing the state of the motor in addition to the control command data S1 and the control feedback data S2. Examples of the state of the motor include the value of a current flowing through the motor, the temperature of the motor, and the like. Changes in the value of the current flowing through the servo motor 50 or the temperature of the servo motor 50 over a machining cycle during the machining of a workpiece seem to be effective data indirectly representing the state of machining of the workpiece. Accordingly, the accuracy of learning by the learning section 110 can be improved by observing, as the state variable S, temporally-consecutive discrete values obtained by sampling the value of the current or the temperature of the servo motor 50 with a predetermined sampling period Δt during a machining cycle.

In yet another modified example of the machine learning device 100 provided in the control device 1, the state observation section 106 may observe, as the state variable S, machine state data S6 representing the state of the servo press 2 in addition to the control command data S1 and the control feedback data S2. Examples of the state of the servo press 2 include the temperature of the servo press 2 and the like. These states may cause differences in results of machining. Accordingly, observing such state as the state variable S can improve the accuracy of learning by the learning section 110.

In yet another modified example of the machine learning device 100 provided in the control device 1, the state observation section 106 may observe, as the state variable S, ambient condition data S7 representing an ambient condition of the servo press 2 in addition to the control command data S1 and the control feedback data S2. Examples of the ambient condition of the servo press 2 include ambient temperature, ambient humidity, and the like. These conditions may cause differences in results of machining. Accordingly, observing such condition as the state variable S can improve the accuracy of learning of the learning section 110.

In yet another modified example of the machine learning device 100 provided in the control device 1, the determination data acquisition section 108 may acquire breakthrough determination data D3 for determining the degree of breakthrough occurring during the machining of a workpiece by the servo press 2 in addition to the workpiece quality determination data D1 and the cycle time determination data D2. Breakthrough is a phenomenon in machining by a servo press, in which when a press axis places pressure on a workpiece and then the workpiece is separated (fractured) from the die, the press axis is suddenly subjected to inverse deformation force. This phenomenon is the main cause of shock and sound noise in so-called shearing work, and affects the quality of machining of the workpiece and the state (such as breakdown) of the servo press. The determination data acquisition section 108 may analyze data such as the torque value of the servo motor 50 during the machining of a workpiece. When breakthrough occurs, the determination data acquisition section 108 may acquire the breakthrough determination data D3 meaning appropriate for breakthrough having a magnitude not more than a predetermined threshold or inappropriate for breakthrough having a magnitude more than the threshold.

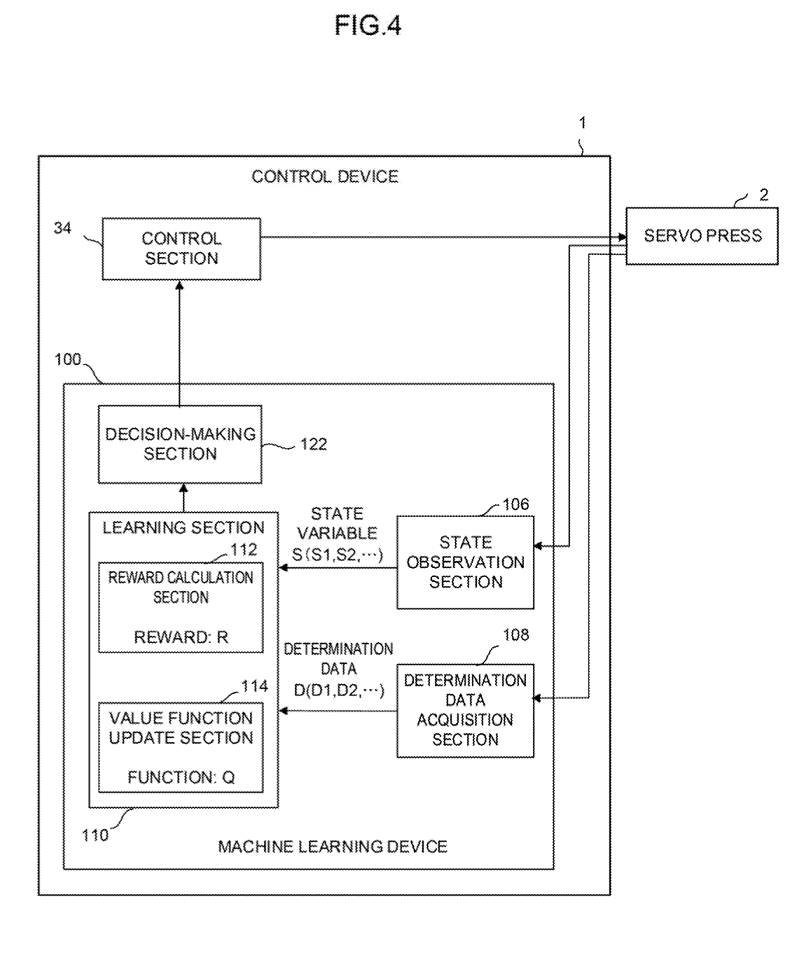

In the machine learning device 100 having the above-described configuration, the learning algorithm executed by the learning section 110 is not particularly limited, and any learning algorithm publicly-known as machine learning can be employed. FIG. 4 illustrates one aspect of the control device 1 illustrated in FIG. 2, which has the configuration including the learning section 110 that executes reinforcement learning as one example of learning algorithm. Reinforcement learning is an approach in which a cycle of observing the current state (that is, input) of an environment where an object to be learned exists, executing a predetermined action (that is, output) in the current state, and giving a certain reward to the action is heuristically repeated, and such a policy (in the machine learning device of the present application, the control command for the servo press 2) that maximizes the total of rewards is learned as an optimal solution.

In the machine learning device 100 provided in the control device 1 illustrated in FIG. 4, the learning section 110 includes a reward calculation section 112 and a value function update section 114. The reward calculation section 112 finds a reward R relating to a result (corresponding to the determination data D that is used in the learning period immediately after the state variable S has been acquired) of determination regarding the machining of a workpiece by the servo press 2 based on the control command for the servo press 2 decided based on the state variable S. The value function update section 114 updates a function Q representing the value of the control command for the servo press 2 using the reward R. The learning section 110 learns the control command for the servo press 2 with respect to the feedback for controlling the servo press 2 by the value function update section 114 repeating the update of the function Q.

One example of a reinforcement learning algorithm that the learning section 110 executes will be described. The algorithm according to this example is known as Q-learning and is an approach in which using, as independent variables, the state s of an agent and an action a that the agent can select in the state s, a function Q(s,a) representing the value of the action in the case where the action a is selected in the state s is learned. Selecting such an action a that the value function Q becomes maximum in the state s is the optimal solution. By starting Q-learning in a state in which the correlation between the state s and the action a is unknown and repeating trial and error in which various actions a are selected in arbitrary states s, the value function Q is repeatedly updated to be brought close to the optimal solution. The value function Q can be brought close to the optimal solution in a relatively short time by employing a configuration in which when an environment (that is, the state s) changes as a result of selecting the action a in the state s, a reward r (that is, a weight given to the action a) corresponding to the change can be obtained, and guiding learning so that an action a yielding a higher reward r may be selected.

An update formula for the value function Q is generally represented as the following Formula 1. In Formula 1, sₜ and aₜ are respectively a state and an action at time t. The action aₜ changes the state to sₜ₊₁. rₜ₊₁ is a reward obtained in response to a change of the state from sₜ to sₜ₊₁. The term of maxQ means Q obtained when an action a that provides a maximum value Q (seems at time t to provide a maximum value Q) is taken at time t+1. α and γ are respectively a learning coefficient and a discount rate, and are set as desired in the range of 0<α≤1 and 0<γ≤1.

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad [ Formula 1 ]$$

In the case where the learning section 110 executes Q-learning, the state variable S observed by the state observation section 106 and the determination data D acquired by the determination data acquisition section 108 correspond to the state s in the update formula, an action regarding how the control command for the servo press 2 should be decided with respect to the current state (that is, the feedback for controlling the servo press 2) corresponds to the action a in the update formula, and the reward R found by the reward calculation section 112 corresponds to the reward r in the update formula. Accordingly, the value function update section 114 repeatedly updates the function Q representing the value of the control command for the servo press 2 with respect to the current state by Q-learning using the reward R.

The reward R found by the reward calculation section 112 may be set as follows: for example, if the machining of a workpiece based on the decided control command for the servo press 2 that is performed after the control command for the servo press 2 is decided is determined to be “appropriate” (for example, the workpiece after machining is not broken, a dimension error of the workpiece is not more than a predetermined threshold, the cycle time of the machining is less than a predetermined threshold or the cycle time in the last learning period, and the like), the reward R is positive (plus); and if the machining of the workpiece based on the decided control command for the servo press 2 that is performed after the control command for the servo press 2 is decided is determined to be “inappropriate” (for example, the workpiece after machining is broken, the dimension error of the workpiece is more than the predetermined threshold, the cycle time of the machining is more than the predetermined threshold or the cycle time in the last learning period, and the like), the reward R is negative (minus). The absolute values of the positive and negative rewards R may be equal or different. With regard to criteria for determination, a plurality of values contained in the determination data D may be combined to make a determination.

Moreover, results of determination regarding the machining of a workpiece based on the set control command for the servo press 2 may be classified into a plurality of grades, not only two grades that are “appropriate” and “inappropriate”. For example, in the case where a threshold of the cycle time of machining of a workpiece is Tₘₐₓ and where T is the cycle time of assemble work by an operator, reward R=5 is given when 0≤T<Tₘₐₓ/5, reward R=3 is given when Tₘₐₓ/5≤T<Tₘₐₓ/2, reward R=1 is given when Tₘₐₓ/2≤T<Tₘₐₓ, and reward R=−3 (minus reward) is given when Tₘₐₓ≤T.

Further, a threshold for use in determination may be set relatively large in the initial phase of learning, and may decrease as learning progresses.

The value function update section 114 may have an action-value table in which the state variables S, the determination data D, and the reward R are organized in relation to action values (for example, numerical values) represented by the function Q. In this case, the action that the value function update section 114 updates the function Q is synonymous with the action that the value function update section 114 updates the action-value table. When Q-learning is started, the correlation between the current state of the environment and the control command for the servo press 2 is unknown. Accordingly, in the action-value table, various state variables S, the determination data D, and the reward R are prepared in a form associated with randomly determined values (function Q) of the action value. It should be noted that if the determination data D is known, the reward calculation section 112 can immediately calculate a reward R corresponding to the determination data D, and the calculated value R is written to the action-value table.

As Q-learning is advanced using the reward R corresponding to the result of determination regarding the operation of the servo press 2, learning is guided in the direction in which an action yielding a higher reward R is selected, and the value (function Q) of the action value of an action that is taken in the current state is rewritten in accordance with the state (that is, the state variable S and the determination data D) of the environment that changes as the result of execution of the selected action in the current state, thus updating the action-value table. By repeating this update, the values (function Q) of action values displayed in the action-value table are rewritten so that reasonable actions (in the present invention, actions to adjust a command value for the servo motor 50 without extremely increasing the cycle time regarding the machining of a workpiece) may have larger values. This gradually reveals the correlation between the current environmental state (the feedback for controlling the servo press 2) that has been unknown and an action (control command for the servo press 2) with respect to the current environmental state. In other words, by updating the action-value table, the relationship between the feedback for controlling the servo press 2 and the control command for the servo press 2 is gradually brought close to the optimal solution.

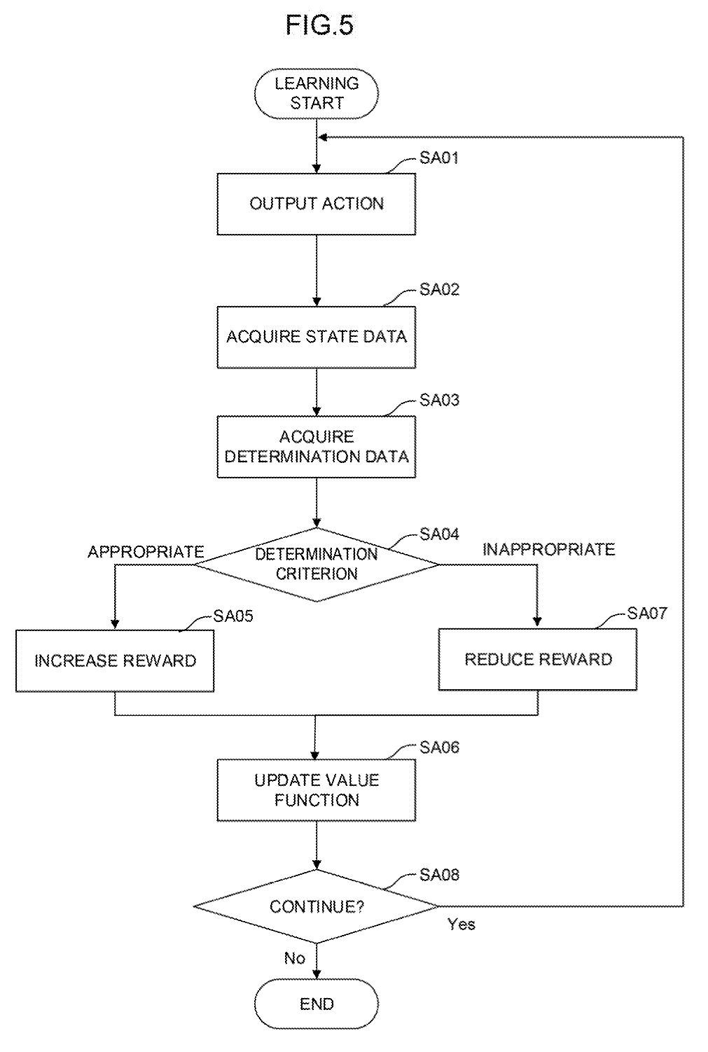

Referring to FIG. 5, the flow (that is, one aspect of the machine learning method) of the above-described Q-learning that the learning section 110 executes will be further described. First, in step SA01, the value function update section 114 randomly selects the control command for the servo press 2 as an action that is taken in the current state represented by the state variable S observed by the state observation section 106, with reference to the action-value table at that time. Next, in step SA02, the value function update section 114 takes in the state variable S of the current state that the state observation section 106 is observing. Then, in step SA03, the value function update section 114 takes in the determination data D of the current state that the determination data acquisition section 108 has acquired. Next, in step SA04, the value function update section 114 determines, based on the determination data D, whether the control command for the servo press 2 has been appropriate. If it has been determined that the control command for the servo press 2 has been appropriate, the value function update section 114 in step SA05 applies, to the update formula for the function Q, a positive reward R that the reward calculation section 112 has found, and then, in step SA06, updates the action-value table using the state variable S and the determination data D in the current state, the reward R, and the value (function Q after update) of the action value. On the other hand, if it has been determined in step SA04 that the control command for the servo press 2 has not been appropriate, the value function update section 114 in step SA07 applies, to the update formula for the function Q, a negative reward R that the reward calculation section 112 has found, and then, in step SA06, updates the action-value table using the state variable S and the determination data D in the current state, the reward R, and the value (function Q after update) of the action value.

The learning section 110 repeatedly updates the action-value table by repeating steps SA01 to SA07, thus advancing the learning of the control command for the servo press 2. It should be noted that the process for finding the reward R and updating the value function from step SA04 to step SA07 is executed for each piece of data contained in the determination data D.

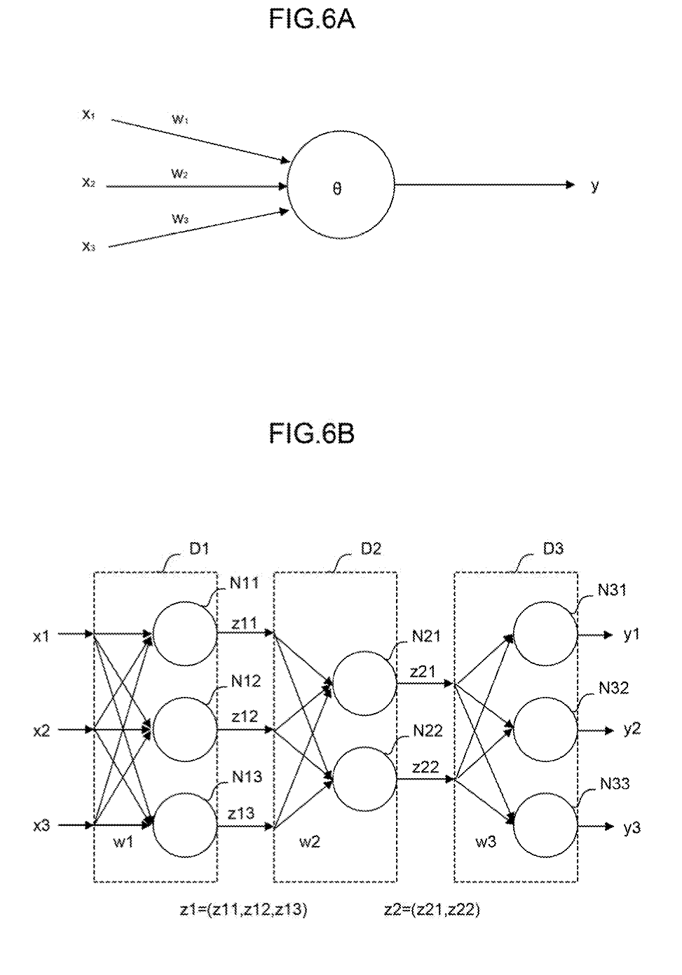

To advance the aforementioned reinforcement learning, for example, a neural network can be applied. FIG. 6A schematically illustrates a model of a neuron. FIG. 6B schematically illustrates a model of a three-layered neural network which is configured by combining the neurons illustrated in FIG. 6A. The neural network can be composed of arithmetic devices, storage devices, or the like, for example, in imitation of the model of neurons.

The neuron illustrated in FIG. 6A outputs a result y with respect to a plurality of inputs x (input x₁ to input x₃ as an example here). Inputs x₁ to x₃ are respectively multiplied by weights w (w₁ to w₃) corresponding to these inputs x. Accordingly, the neuron outputs the output y expressed by Formula 2 below. Here, in Formula 2, all of input x, output y, and weight w are vectors. Further, θ denotes a bias and fₖ denotes an activation function.

y=fₖ(Σᵢ₌₁ⁿxᵢwᵢ−θ) [Formula 2]

In the three-layered neural network illustrated in FIG. 6B, a plurality of inputs x (input x1 to input x3 as an example here) are inputted from the left side and results y (result y1 to result y3 as an example here) are outputted from the right side. In the example illustrated in FIG. 6B, inputs x1, x2, x3 are each multiplied by corresponding weights (collectively denoted by w1) and each of inputs x1, x2, x3 is inputted into three neurons N11, N12, N13.

In FIG. 6B, an output of each of the neurons N11, N12, N13 is collectively denoted by z1. z1 can be considered as a feature vector obtained by extracting a feature amount of an input vector. In the example illustrated in FIG. 6B, feature vectors z1 are each multiplied by corresponding weights (collectively denoted by w2) and each of feature vectors z1 is inputted into two neurons N21, N22. Feature vector z1 represents a feature between weight w1 and weight w2.

In FIG. 6B, an output of each of the neurons N21, N22 is collectively denoted by z2. z2 can be considered as a feature vector obtained by extracting a feature amount of feature vector z1. In the example illustrated in FIG. 6B, feature vectors z2 are each multiplied by corresponding weights (collectively denoted by w3) and each of feature vectors z2 is inputted into three neurons N31, N32, N33. Feature vector z2 represents a feature between weight w2 and weight w3. Finally, neurons N31 to N33 respectively output results y1 to y3.

Here, the method of so-called deep learning in which a neural network having three or more layers is used may be employed as well.

In the machine learning device 100 provided in the control device 1, the learning section 110 can use a neural network as a value function in Q-learning to perform multi-layer calculation following the above-described neural network using the state variable S and the action a as the input x, thus outputting the value (result y) of the action in the state. It should be noted that operation modes of the neural network include a learning mode and a value prediction mode. For example, weights w are learned using a learning data set in the learning mode, and the value of an action can be determined using the learned weights w in the value prediction mode. It should be noted that in the value prediction mode, detection, classification, inference, and the like can also be performed.

The above-described configuration of the control device 1 can be described as a machine learning method (or software) that the processor 101 executes. This machine learning method is a machine learning method for learning the control command for the servo press 2. The machine learning method includes: a step of observing the control command data S1 and the control feedback data S2 as the state variables S representing the current state of an environment in which the servo press 2 operates; a step of acquiring the determination data D representing a result of determination regarding the machining of a workpiece based on the decided control command for the servo press 2; and a step of learning the control command for the servo press 2 in relation to the control feedback data S2 using the state variables S and the determination data D. In this method, the steps are performed by a CPU of a computer.

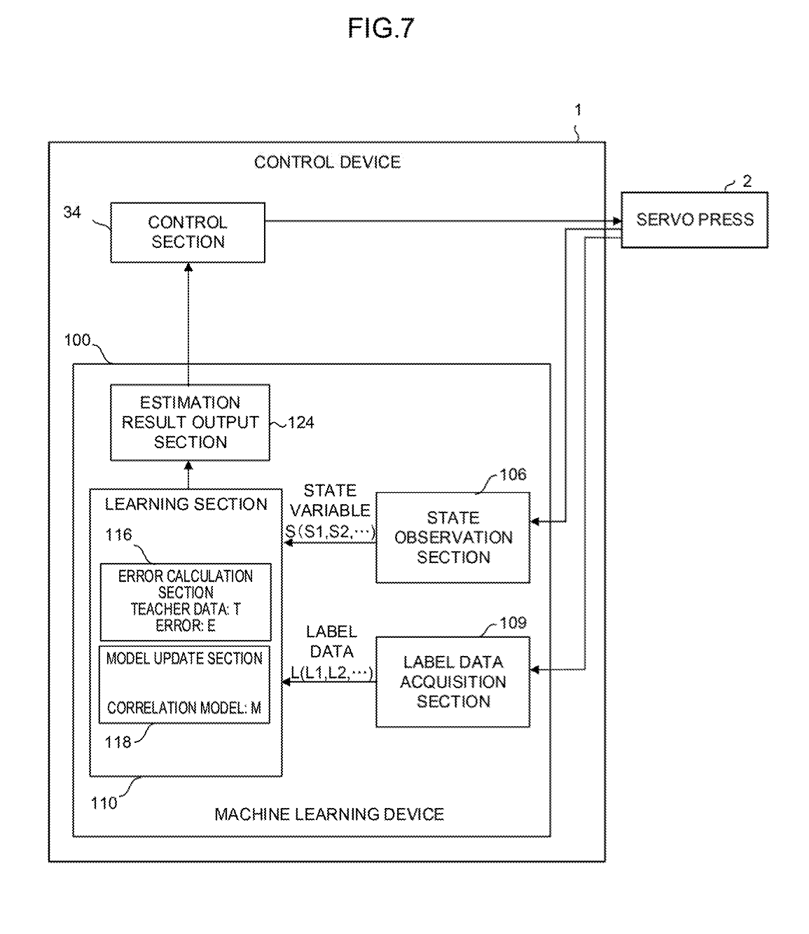

FIG. 7 is a functional block diagram schematically illustrating the control device 1 and the machine learning device 100 according to a second embodiment, and illustrates a configuration including the learning section 110 that executes supervised learning as another example of a learning algorithm. Supervised learning is a method for learning a correlation model for estimating a required output with respect to a new input by preparing known data sets (called teacher data), each of which includes an input and an output corresponding thereto, and identifying features implying the correlation between input and output from the teacher data.

The machine learning device 100 provided in the control device 1 of the present embodiment includes, instead of the determination data acquisition section 108, a label data acquisition section 109 for acquiring label data L containing control command data L1 representing the control command for the servo press 2 with which machining has been appropriately performed with respect to an environmental state.

The label data acquisition section 109 can use the control command for the servo press 2 which is regarded as appropriate in a certain state. The label data L may be acquired as follows: the feedback for controlling the servo press 2 (control feedback data S2) is recorded as log data when the servo press 2 has operated in the past; the log data is analyzed; and data on the control command for the servo press 2 with which the machining of a workpiece is given a good grade without increasing the machining cycle time more than necessary is acquired as data on an appropriate control command (control command data L1). How to define appropriate control command data may be the same as in the determination of the determination data D in the first embodiment.

The state observation section 106 of the present embodiment does not need to observe the control command data S1. The label data acquisition section 109, similar to the determination data acquisition section 108, is an essential component in a learning phase of the learning section 110, but is not necessarily an essential component after the learning section 110 completes learning the control command for the servo press 2 in relation to the feedback for controlling the servo press 2.

In the machine learning device 100 provided in the control device 1 illustrated in FIG. 7, the learning section 110 includes an error calculation section 116 and a model update section 118. The error calculation section 116 calculates an error E between a correlation model M for estimating the control command for the servo press 2 from the feedback for controlling the servo press 2 and a correlation feature identified from the teacher data T obtained from the feedback for controlling the servo press 2 acquired in the past and a result of an appropriate control command for the servo press 2. The model update section 118 updates the correlation model M so that the error E may be reduced. The learning section 110 learns an estimation of the control command for the servo press 2 based on the feedback for controlling the servo press 2 by the model update section 118 repeating the updating of the correlation model M.

An initial value of the correlation model M is, for example, a value expressing the correlation between the state variable S and the label data L in a simplified manner (for example, by the N-th order function), and is given to the learning section 110 before the start of supervised learning. In the present invention, as described previously, the teacher data T may be the feedback for controlling the servo press 2 acquired in the past and data on the appropriate control command for the servo press 2 corresponding to the feedback, and are given to the learning section 110 as needed when the control device 1 is operated. The error calculation section 116 identifies a correlation feature implying the correlation between the feedback for controlling the servo press 2 and the control command for the servo press 2 based on the teacher data T given to the learning section 110 as needed, and finds an error E between the correlation feature and the correlation model M corresponding to the state variable S in the current state and the label data L. The model update section 118 updates the correlation model M so that the error E may be reduced, in accordance with, for example, predetermined update rules.

In the next learning cycle, the error calculation section 116 estimates the control command for the servo press 2 in accordance with the updated correlation model M using the state variable S and finds an error E between a result of the estimation and the label data L actually acquired, and the model update section 118 updates the correlation model M again. This gradually reveals the correlation between the current environmental state that has been unknown and the estimation corresponding to the current environmental state. It should be noted that in the second embodiment, various things may be observed as the state variables S as in the first embodiment.

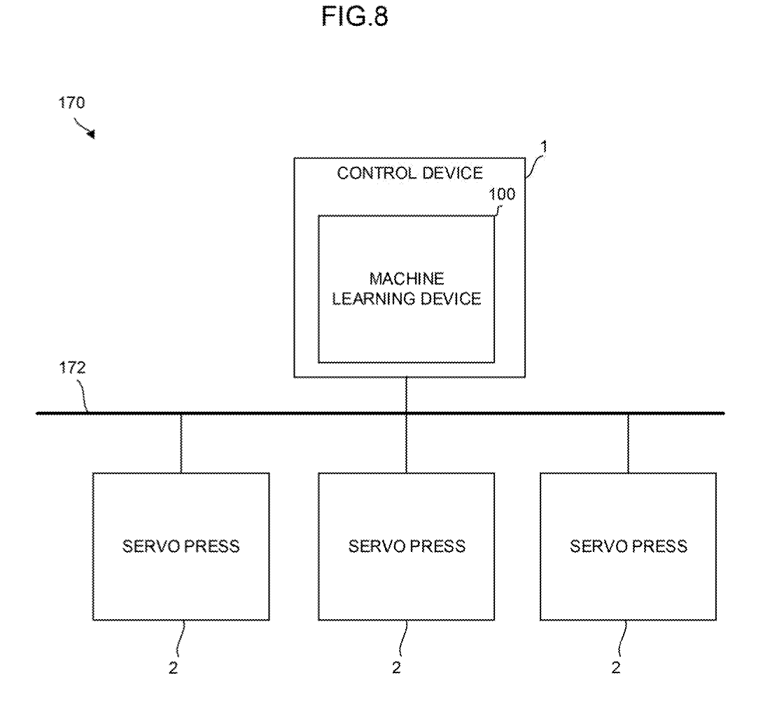

FIG. 8 illustrates a system 170 according to a third embodiment, which includes the control device 1. The system 170 includes at least one control device 1 implemented as part of a computer, such as a cell computer, a host computer, or a cloud server, a plurality of servo presses 2 to be controlled, and a wired/wireless network 172 that connects the control device 1 and the servo presses 2 to each other.

In the system 170 having the above-described configuration, the control device 1 including the machine learning device 100 can automatically and accurately find a control command for each servo press 2 with respect to the feedback for controlling the servo press 2, using a result of learning by the learning section 110. Further, the system 170 may be configured so that the machine learning device 100 of the control device 1 can learn the control command for the servo press 2 common to all the servo presses 2 based on the state variable S and the determination data D, which are obtained for each of the plurality of servo presses 2, and a result of the learning can be shared among all the servo presses 2 during the operation thereof. With the system 170, the speed and reliability of learning of the control command for the servo press 2 can be improved using more various data sets (containing the state variable S and the determination data D) as inputs.

The embodiments of the present invention have been described above, but the present invention can be embodied in various aspects by adding arbitrary alterations, without being limited only to the examples of the above-described embodiments.

For example, the learning algorithm and the arithmetic algorithm that the machine learning device 100 executes, the control algorithm that the control device 1 executes, and the like are not limited to the above-described ones, and various algorithms can be employed.

The above-described embodiments include the description that the control device 1 and the machine learning device 100 are devices including CPUs different from each other, but the machine learning device 100 may be realized by the CPU 11 included in the control device 1 and the system program stored in the ROM 12.

1. A control device for controlling a servo press that machines a workpiece with a die, the control device comprising:
a machine learning device for learning a control command for the servo press, wherein
the machine learning device includes
a state observation section for observing control command data representing the control command for the servo press and control feedback data representing feedback for controlling the servo press as a state variable representing a current environmental state,
a determination data acquisition section for acquiring workpiece quality determination data for determining quality of a workpiece machined based on the control command for the servo press as determination data representing a result of determination regarding machining of the workpiece, and
a learning section for learning the control command for the servo press in relation to the feedback for controlling the servo press using the state variable and the determination data.

2. The control device according to claim 1, wherein the determination data acquisition section further acquires cycle time determination data for determining time taken to machine the workpiece as determination data.

3. The control device according to claim 1, wherein
the learning section includes
a reward calculation section for finding a reward relating to the result of determination, and
a value function update section for updating a function representing a value of the control command for the servo press with respect to the feedback for controlling the servo press using the reward, and
the reward given by the reward calculation section increases with increasing quality of the workpiece and decreasing time taken to machine the workpiece.

4. The control device according to claim 1, wherein the learning section performs arithmetic on the state variable and the determination data by multi-layer calculation.

5. A control device for controlling a servo press that machines a workpiece with a die, the control device comprising:
a machine learning device that has learned a control command for the servo press, wherein
the machine learning device includes
a state observation section for observing control command data representing the control command for the servo press and control feedback data representing feedback for controlling the servo press as a state variable representing a current environmental state,
a learning section that has learned the control command for the servo press in relation to the feedback for controlling the servo press, and
a decision-making section for deciding the control command for the servo press based on the state variable observed by the state observation section and a result of learning by the learning section.

6. The control device according to claim 1, wherein the machine learning device is on a cloud server.

7. A machine learning device for learning a control command for a servo press that machines a workpiece with a die, the machine learning device comprising:
a state observation section for observing control command data representing the control command for the servo press and control feedback data representing feedback for controlling the servo press as a state variable representing a current environmental state;
a determination data acquisition section for acquiring workpiece quality determination data for determining quality of a workpiece machined based on the control command for the servo press as determination data representing a result of determination regarding machining of the workpiece; and
a learning section for learning the control command for the servo press in relation to the feedback for controlling the servo press using the state variable and the determination data.

8. A machine learning device that has learned a control command for a servo press for machining a workpiece with a die, the machine learning device comprising:
a state observation section for observing control command data representing the control command for the servo press and control feedback data representing feedback for controlling the servo press as a state variable representing a current environmental state;
a learning section that has learned the control command for the servo press in relation to the feedback for controlling the servo press; and
a decision-making section for deciding the control command for the servo press based on the state variable observed by the state observation section and a result of learning by the learning section.
